(19) United States
(12) Patent Application Publication
(10) Pub. No.: US 2023/0314594 A1
(43) Pub. Date: Oct. 5, 2023

(54) SLOPE FAILURE MONITORING SYSTEM

(71) Applicant: GroundProbe Pty Ltd, Windsor, Queensland (AU)

(72) Inventor: Lachlan CAMPBELL, Windsor (AU)

(21) Appl. No.: 18/022,603

(22) PCT Filed: Aug. 25, 2021
(86) PCT No.: PCT/AU2021/050958

§ 371 Date: Feb. 22, 2023

(30) Foreign Application Priority Data
Aug. 25, 2020 (AU) 2020903032

(51) Int. Cl. G01S 13/86; G01S 13/88; G01S 13/72; G01S 7/04; G06T 7/292; G06T 7/246; G08B 21/02

(52) U.S. Cl. CPC G01S 13/867; G01S 13/886; G01S 13/72; G01S 7/04; G06T 7/292; G06T 7/248; G08B 21/02; G06T 2207/10016; G06T 2207/20221; G06T 2207/10028; G06T 2200/24

(57) ABSTRACT

A slope failure monitoring system comprising: a 2D Doppler radar that acquires azimuth and range data of moving radar targets in a scene; a 2D high definition imaging device operating in an optical frequency band that acquires azimuth and elevation data of moving image targets in the scene; and a processing unit that processes azimuth and range data from the Doppler radar and azimuth and elevation data from the imaging device to: identify moving radar targets and moving image targets having matching azimuth data as a moving target; fuse azimuth and range data from the Doppler radar with azimuth and elevation data from the imaging device and generates azimuth, range and elevation data of the moving target; and determine a 3D location of the moving target in the scene.

### FIELD OF THE INVENTION

The present invention relates to the general field of geo-hazard monitoring. More particularly, the invention relates to a device that raises an alarm when a slope fails. The invention has particular application for raising alarm if a dam wall or similar fails, or there is a rock fall or similar.

### BACKGROUND TO THE INVENTION

It is known to monitor for slope failure using Radar and Lidar. By way of example, reference may be had to International Patent Publication number WO2002046790, assigned to GroundProbe Pty Ltd, which describes a slope monitoring system that utilizes an interferometric radar and a video camera to predict slope failure. Reference may also be had to International Patent Publication number WO2017063033, assigned to GroundProbe Pty Ltd, which describes a slope stability Lidar system that uses a laser to make direction, range and amplitude measurements from which slope movement can be determined.

The inventions described in WO2002046790 and WO2017063033 have proven to be effective for early detection of precursory slope movement that occurs before a collapse, particularly in open cut mining situations. However, in the case of tailings dams, recent failures have led to significant loss of life for communities downstream from the impoundments, and a redundant alarming system that is triggered by the flow of the debris at the point of collapse, in some situations, is required as a last resort alarm.

In recent times there have been a number of failures of tailing dams with catastrophic results. There are about 3500 tailing dams around the world and, on average, 3 fail each year. In a recent article by Zongjie et. al. in Advances in Civil Engineering (Vol 2019), the authors state that the average failure rate for tailings dams over the last 100 years is 1.2% compared to 0.01% for traditional water storage dams. There is a need for a system to monitor a dam wall and provide an instant alarm of failure. However, many tailings dams are covered with vegetation, which can lead to sub-optimum monitoring outcomes when employing the existing systems described above. Furthermore, it is known that tailings dams may display a degree of seepage, without necessarily indicating failure. Unfortunately, moisture can further impact the accuracy of monitoring using current systems. Thus, as a result of the combined effects of vegetation and moisture, alternate dam wall monitoring systems are desirable.

In the application of slope monitoring, particularly in open cut mines, geologically small rock falls ranging in size from centimeters to meters in size, can have minimal precursor movement before collapse and often are smaller than the resolution of existing systems, meaning that in some situations detecting these collapses remains a problem. The impact of small rock falls can accumulate over time, so an instant alarm of each rock fall can be useful.

### SUMMARY OF THE INVENTION

In one form, although it need not be the only or indeed the broadest form, the invention resides in a slope failure monitoring system comprising: a 2D Doppler radar that acquires azimuth and range data of moving radar targets in a scene; a 2D high definition imaging device operating in an optical frequency band that acquires azimuth and elevation data of moving image targets in the scene; a processing unit that processes azimuth and range data from the Doppler radar and azimuth and elevation data from the imaging device and: identifies moving radar targets and moving image targets having matching azimuth data as a moving target; fuses azimuth and range data from the Doppler radar with azimuth and elevation data from the imaging device and generates azimuth, range and elevation data of the moving target; and determines a 3D location of the moving target in the scene; a display that shows at least the scene and the location of the movement in the scene; and an alarm unit that generates an alarm when movement of the moving target is detected above a threshold according to criteria.

Preferably the 2D Doppler radar operates in the X, Ku, K or Ka frequency bands. These frequency bands cover a frequency range of 8 GHz to 40 GHz. Most preferably the 2D Doppler radar operates in the X radar frequency band, which is generally acknowledged as the range 8-12 GHz. The optical frequency band includes the visible frequency band, the ultraviolet frequency band and the infrared frequency band, spanning a frequency range from about 300 GHz to 3000 THz. The Inventor has found that the X-band is particularly useful as it provides greater penetration through dust, rain or other particulate disturbances.

Persons skilled in the art will understand a Doppler radar to be a specialised radar that uses the Doppler effect to produce velocity data about objects at a distance.

The imaging device is suitably a video camera that records a sequence of optical images of a scene. The device may continuously stream an image of a scene or transmit a sequence of still images in real time. The imaging device may image using illumination from sunlight, moonlight, starlight or artificial light, or it may image using thermal infrared.

The processing unit may be a single device that performs all required processing of data obtained from the Doppler radar and imaging device. Preferably, the processing unit comprises multiple processing elements that work together to provide the necessary processing. Specifically, radar data may be processed in a processing element on board the Doppler radar and image data may be processed by a processing element on board the imaging device. A further processing element may process output from the radar processing element and the imaging device processing element. The various processing elements together comprise the processing unit. The processing unit may also incorporate the alarm unit.

By “matching azimuth data” is meant that the azimuth determined for the moving radar target and the azimuth determined for the moving image target are the same or overlapping within an acceptable degree of error so that they are decided to be from the same moving target.

By “a threshold according to criteria” is meant that various threshold requirements may be applied to the alarm decision. The threshold criteria may be applied to the azimuth and range data acquired from the 2D Doppler radar, the azimuth and elevation data acquired from the 2D high definition imaging device, or the fused azimuth, range and elevation data. For instance, threshold criteria may be that movement may need to occur above a set velocity or moving targets may need to be above a set size.

The processing unit may also apply filters. For instance, movement may need to be within a defined area, or there may be excluded areas in which movement is disregarded.

The slope failure monitoring system may monitor for catastrophic failure, such as the failure of a dam wall, and give early warning to minimise downstream damage or loss of life. Alternatively, the slope failure monitoring system may monitor for non-catastrophic failure, such as rock falls at a mining site, and give ongoing warning so that accumulated impact may be assessed.

In a further form, the invention resides in a method of monitoring a slope for failure, including the steps of: co-locating a Doppler radar and an imaging device at a common origin with a shared or overlapping field of view of a scene; calibrating the Doppler radar and the imaging device to have the same line of sight; synchronizing timing of data collection and processing of data collected from the Doppler radar and the imaging device on one or more processing units using detection and tracking algorithms to detect common moving targets identified by the Doppler radar and the imaging device; and raising an alarm if a common moving target satisfies one or more criteria.

Further features and advantages of the present invention will become apparent from the following detailed description.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, in which:

FIG. 1 is a block diagram of a slope failure monitoring system according to the invention;

FIG. 2 is an image of a Doppler radar suitable for the slope failure monitoring system of FIG. 1;

FIG. 3 is an image of a high definition video camera suitable for the slope failure monitoring system of FIG. 1;

FIG. 4 is an image of a processing unit suitable for the slope failure monitoring system of FIG. 1;

FIG. 5 is a typical display produced by the processing unit of FIG. 4;

FIG. 6 shows a display in which the slope failure monitoring system range is overlayed on a plan view of a location; and

FIG. 7 is an enlarged view of a portion of FIG. 6 demonstrating alarm zones;

FIG. 8 shows a display in which the slope failure monitoring system shows a target in both azimuth and range overlayed on a plan view of a location and the same target in azimuth and elevation overlayed on a front view of a location;

FIG. 9 shows a display in which the slope failure monitoring system shows a different target in both azimuth and range overlayed on a plan view of a location and the same target in azimuth and elevation overlayed on a front view of a location;

FIG. 10 shows a display in which the slope failure monitoring system shows a 3D location of a target based on a shared azimuth location with range and elevation on a 3D synthetic view of a location;

FIG. 11 shows a different 3D view of the FIG. 10;

### DETAILED DESCRIPTION OF THE INVENTION

Embodiments of the present invention reside primarily in a slope failure monitoring system and a method of slope failure monitoring. Accordingly, the elements of the system and the method steps have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order. Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

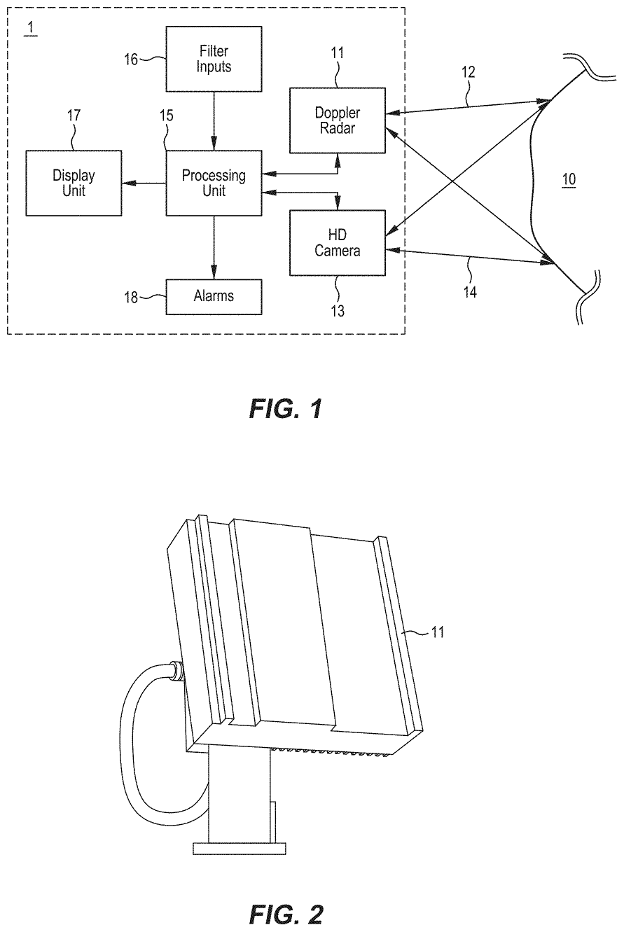

Referring to FIG. 1 there is a shown a block diagram of a slope failure monitoring system, indicated generally as 1. The slope failure monitoring system 1 is, for the purposes of explanation, depicted as monitoring a portion of a dam wall, 10. The system 1 comprises a Doppler radar 11 that scans 12 the portion of the dam wall and a high definition camera 13 that scans 14 the same portion of the dam wall. The data from the radar 11 and camera 13 is transmitted to a processing unit 15 that analyses the data to identify movement. Various threshold criteria and filters may be input by a user using an input device 16. The portion of the dam wall being monitored and the results of the data processing is displayed on a display unit 17. The display unit 17 may be a remote display unit, a local display unit or both. The system generates alarms which are output by alarm unit 18. Each of the elements of the slope failure monitoring system 1 is described in more detail below.

Turning now to FIG. 2, there is shown a Doppler (frequency modulated continuous wave—FMCW) radar 11 that is suitable for the slope failure monitoring system of FIG. 1. The radar 11 operates in the X-band frequency, which is a range of about 8 GHz to 12 GHz. The specific radar shown in FIG. 2 operates at 9.55 GHz. The radar 11 uses electronic beam steering to instantly scan every azimuth position every 250 milliseconds (4 scans per second). It has a coverage of 90 degrees in azimuth and 60 degrees in elevation. The effective range is 5.6 km with a maximum range of 15 km. It is able to detect a target of 0.3 m×0.3 m at 1 km, a person-size target at a range of 2.5 km and a 4 m×4 m target at 15 km. It has a 100 MHz bandwidth that results in a range resolution of 1.5 m. On-board processing provides automatic georeferencing to give speed, size, direction, location and amplitude of targets. As an alternative, target detection can be performed in the processing unit 15.

The Doppler radar may alternatively operate in the Ku frequency band (12 GHz to 18 GHz), the K band (18 GHz to 27 GHz) or the Ka band (27 GHz to 40 GHz). It will be understood that the parameters of operation will vary somewhat at the different bands. Increasing the frequency of the Doppler radar system acts to increase the resolution of the system, whilst sacrificing its immunity to atmospheric turbulence, rain, snow, hail, dust and fog which can act to reduce the effective operating range and also can create a higher level of Radar clutter which in turn will lead to a greater false alarm rate. By using fused data from an image sensor and the Doppler radar sensor an ‘AND’ alarm can help filter these false alarms.

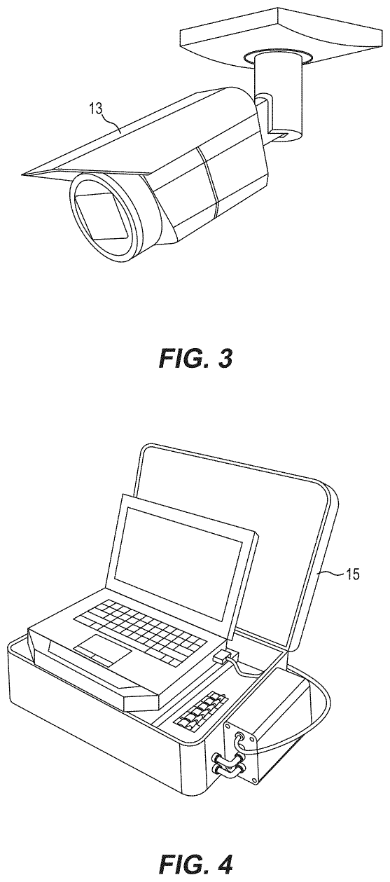

Turning now to FIG. 3, there is a shown an imaging device, which in the embodiment is a high definition camera 13 that is suitable for the slope failure monitoring system of FIG. 1. The camera of FIG. 3 has 4 k resolution. It has a 90-degree field of view with on-board processing to provide digital noise reduction and a wide dynamic range. The camera has a 5×optical zoom and 10×digital zoom. The digital data output is suitable for a range of video analytics. The camera 13 operates in the visible spectrum by day and the infrared spectrum by night. The camera has a processor on-board for computer vision processing for target detection (video analytics). But alternatively, the target detection can be performed in the processing unit 15.

The Doppler radar 11 and camera 13 are co-located having a common origin and a common line-of-sight. By effectively bore-sighting the radar and camera the need for processing to eliminate parallax error is avoided.

Data is collected from the radar 11 and camera 13 by the processing unit 15. The processing unit 15 provides signal processing and alarm validation. The radar 11 and camera 13 are controlled by the processing unit 15 using a shared clock signal for synchronized data processing. Movement, such as rock fall or wall collapse, may be detected by either or both of the radar and camera. Both the camera and the radar record the azimuth location of movement so if the data from both has a common azimuth location the data is fused to provide azimuth, elevation and range (elevation from the camera, range from the radar and azimuth from both) to determine a 3D location. Other data is captured to define the object and the nature of the movement, such as intensity, colour and object identification from the camera, and velocity, size, amplitude, range bins, azimuth bins and direction from the radar.

Fusing of the data from the 2D Doppler radar and the 2D high definition imaging device may be performed by various processes, but the Inventor has found a particularly useful process. In this process, targets with an overlapping azimuth location in their buffer zones are fused by defining a bounding box around the raw detected target in the radar data and the imaging sensor data. The centroid of each bounding box is found. The two azimuth centroids are then averaged to give an azimuth coordinate. The centroid of the bounding box of the target in the image sensor data defines the elevation coordinate, while the range value of the centroid of the bounding box of the radar target gives the range coordinate. The inventor has found the method to be robust due to the inherent averaging properties of a bounding box even if the size of the box changes.

Referring now to FIG. 4, there is shown a processing unit 15, which in the embodiment is in a ruggedized case for field use. The processing unit receives data from the radar 11 and camera 13, which is analysed in real time. The processing unit 15 also sends out signals to control the radar and camera, such as for remote operation of the 5×optical zoom of the camera or the scanning region of the camera and radar.

Radar data is processed with a detailed signal processing chain that is known to those skilled in the art, whereby Doppler targets are detected and tracked over time. Using input parameters including radar cross section estimates of the target as well as velocity and location, the target is then subsequently tracked using standard Doppler target tracking algorithms to filter the noise of trees, long grass, oscillating objects, heavy rain or other sources of error. Suitable Doppler target tracking algorithms will be known to persons skilled in the art. Once a target is tracked between scans and successfully passes through various standard filters, it is then passed to the alarm processing chain.

The camera signal processing chain uses two forms of image processing to detect changes. The first of which is a system of background subtraction, the second is a convolutional neural network (CNN).

For the background subtraction technique, a preprocessing stage occurs whereby a single frame from the video is converted to a monochromatic scale to represent intensity, then its pixels are averaged or convoluted in a spatial neighbourhood to minimize noise. The subsequent step is the preparation of a background model whereby the scene is averaged over several frames to establish a background model. This background model is typically updated in real time and contains typically several seconds of data trailing behind the real-time frame. A real-time frame containing both background and foreground data is also preprocessed in the same way before it has the background model subtracted from the real-time frame. The resulting data is foreground data only, which requires subsequent processing based on the size of the detected area to further remove errors and new data thresholding and intensity histogram binning to increase the signal to noise ratio. The foreground data then becomes a target, which is passed through standard tracking algorithms to filter the noise of trees, long grass, oscillating objects, heavy rain, fog or other sources of error. Data that successfully passes through the tracking filter is then passed to the alarm processor.

CNN is a family of image processing techniques that involve the pre-training of a model which is achieved by obtaining a labelled dataset of multiple images of the object requiring identification, convoluting or spatially averaging each image, feature extraction, inputting the features as a defined number of nodes of an input layer of a neural network, determining a number of abstraction layers or hidden layers, and outputting an output layer with a matching number of nodes in the output layer. Once a model is successfully trained to detect objects that could be the source of true alarm targets including geo-hazards, rocks, falling rocks, collapses, debris flow, lava flow and the like, as well as potential other targets such as machinery, vehicles, trucks, birds, people or animals, the model is then deployed in the slope monitoring system processor. Real-time frames from the camera are then convoluted and fed into the neural network and the output determines the classification of the type of target and segmentation of the image into a background and a target. The target is then tracked over several frames to reduce false alarms. The output of the tracking filter is then passed to the alarm processor.

The alarm processor takes the filtered radar data and calculates the centroid of each tracked target in azimuth and range as primary locators as well as secondary ancillary data including velocity, tracked direction as a vector of azimuth and range, amplitude, radar cross-section (RCS), quality and dimensions in azimuth and range.

The alarm processor takes the output of the filtered tracking object data from the video data and calculates the centroid of each tracked target in azimuth and elevation as primary locators as well as secondary ancillary data including tracked direction as a vector of azimuth and elevation, the RGB values of each pixel being tracked, a quality metric for the tracked target, object classification and detection labels and dimensions in azimuth and range.

The alarm processor adds a user-defined buffer zone to the tracked radar data in degrees. In the case of the tracked video data the buffer zone is defined as a percentage of the size of the target to allow for changes in apparent detected size based on range.

Targets with shared or overlapping azimuth locations anywhere within the buffer zone of both the tracked video target and the tracked radar target are assessed to be common targets. These targets are then fused to determine 3D location in azimuth, elevation and range. These coordinates may then be transformed to real world coordinates. Ancillary data from both targets are also fused to give detailed radar and image descriptions of the target.

Fused data and ancillary data can be displayed in a real plan view range-and-azimuth map in a radar native format, or in a real front view video frame, or in a synthetic 3D map.

As mentioned above, a User may input various filters to the invention. For instance, a User may define a spatial alarm zone in which moving targets are identified and tracked, but outside of which moving targets are ignored. One application of such a scenario may be for monitoring safety along a haul road. A User may define a blind corner as a spatial alarm zone and set an alarm to warn drivers if a rock fall occurs in the zone. This would be a non-catastrophic rock fall but may be important to avoid vehicle damage.

A User may also input various threshold criteria. Key criteria may include speed of the moving target, size of the moving target defined by the number of pixels in either dimension the target occupies, or the radar cross section, or number of individual moving targets moving together, and the direction or bearing of the moving target or targets.

The invention operates in ‘AND’ mode. An ‘AND’ alarm is triggered if a target with a shared or overlapping azimuth location anywhere within the buffer zone of both the tracked image data and the tracked radar data is detected and a target is within the defined alarm zone.

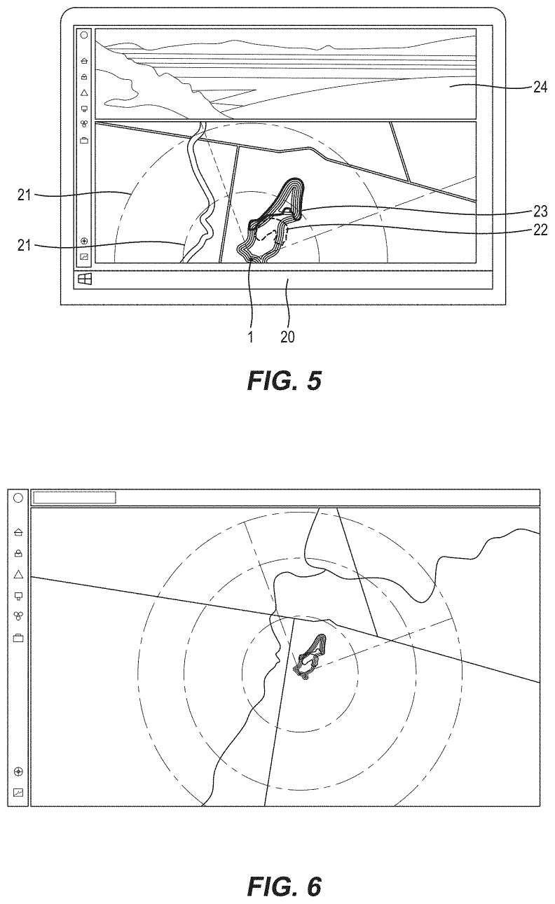

The processing unit 15 may include a local display, alternately or in addition there may be a remote display. In one embodiment a display is provided in a central monitoring location from which control signals may also be sent. A typical display 20 is shown in FIG. 5. The display 20 may provide the output from the camera in one part of the image, in the case of FIG. 5 it is at the top. The lower part of FIG. 5 shows a plan view of the monitored location and surrounding area. Filter Inputs are provided by which a User may apply alarm zones, masks, internal alarm zone masks, and other spatial filters as shown in Table 1, which can be used separately or in combination. The Filters may also apply to the display so that only movement of interest is shown.

Threshold criteria may also be input by a User to only generate an alarm for movement that satisfies certain criteria, such as those listed in Table 2. It does not matter whether the Filters and Thresholds are applied to the raw data from the radar and the imaging device, or to the fused data.

Alarms generated can be visualized on the display 20 as boxes or polygons, visualized in front-view, plan view or a synthetic 3D view as map items. Alarms also include on-screen alert boxes containing action information which can be acknowledged or snoozed or muted on local or remote displays and logged for audit purposes as to which User took which action at what time. Alarms also include triggering external alarming devices by use of connected relays and Programmable Logic Controllers (PLCs), which trigger external alarm devices such as audible, visual or tactile alarm devices. The system also triggers cloud-based digital outputs including emails, SMS messages, smart phone push notifications and automated phone calls which play either pre-recorded messages upon answering or text-to-voice messages upon answering.

A number of range indicators 21 are shown in FIG. 5. These are arranged concentrically from the location of the slope failure monitoring system 1. Also shown in FIG. 5 is an alarm zone 22 in red which is a spatial area wherein specific alarm filters and criteria are applied to incoming data which, if it meets the alarm criteria, triggers specific outputs and a separate polygon zone 23 in yellow is also visualized with a different combination of inputs and outputs. These are shown for illustration purposes, but could equally be overlapping and contain internal holes or mask areas. FIG. 5 also illustrates the overlapping scan field of view of the imaging system 24 shown in its native 2D sensing format of Azimuth and Elevation.

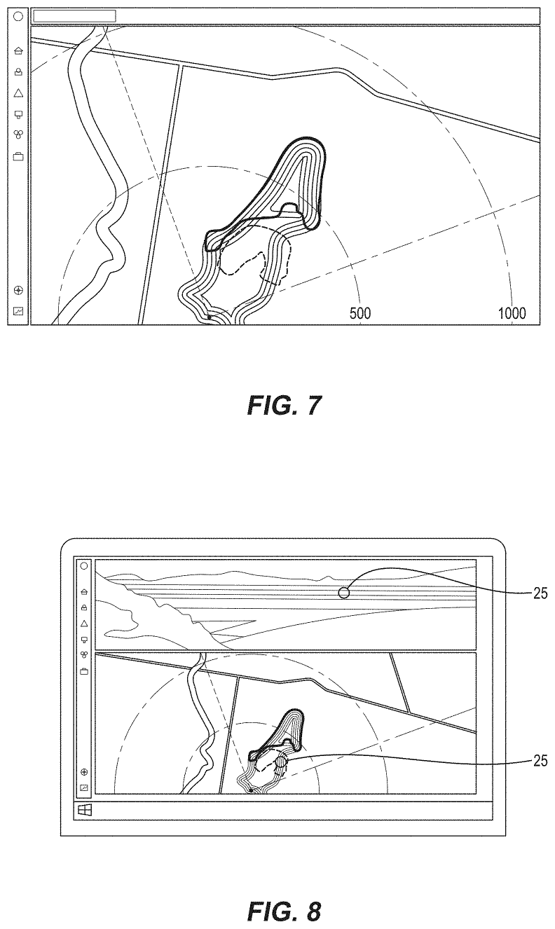

FIG. 6 shows an enlarged view of the radar data on a plan view of a scene to provide greater context where the final range ring shows the extent of the radar scanning range. FIG. 7 shows an enlarged view of the alarm zones 22 and 23 in the radar native field.

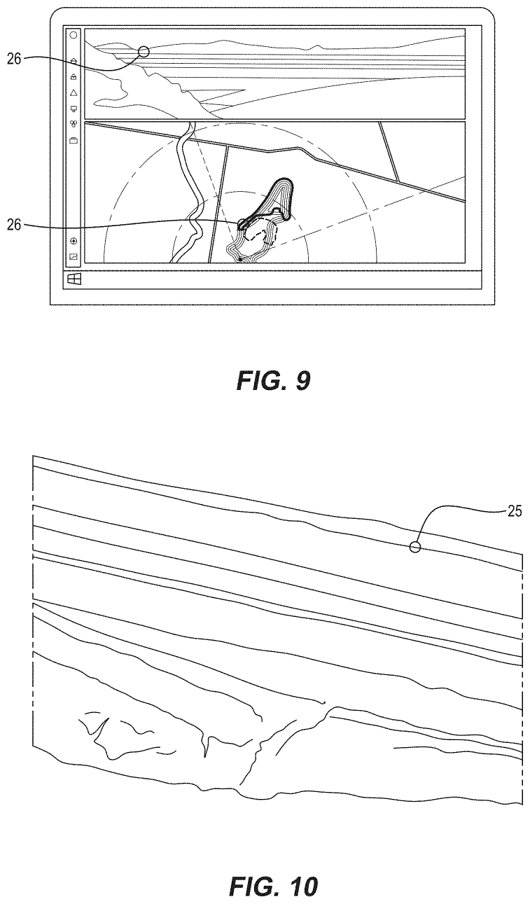

The invention is displayed in use in FIG. 8 where a common target 25 is detected in the camera view in Azimuth and Elevation coordinates from the processed image data, and the same target is shown in Azimuth and Range coordinates from the processed radar data, which triggers an ‘AND’ alarm. FIG. 9 shows a second common target 26 which has secondary detection characteristics detected in the second yellow alarm zone 23 in the native radar data and also in the camera data, which can be filtered with different alarming parameters and have distinct alarm outputs to FIG. 8.

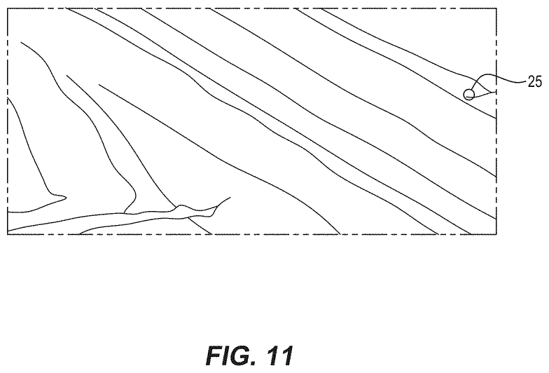

FIG. 10 shows synthetic 3D visualization of the fused radar and image processed data where shared or similar Azimuth coordinates have been used to define the 3D location of the target 25 by taking the shared Azimuth data and fusing it with the radar Range data and the camera Elevation data to give a 3D location. In FIG. 11 secondary data of the estimated size of the target is shown, next to a transformed 3D coordinate expressed in Easting, Northing and Relative Elevation at the bottom of the screen in text. Note that the 3D representation in FIG. 11 is rotated with respect to the view in FIG. 10.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

TABLE 1

| Filter | Description |
|---|---|
| Radar data mask | A filter where all data within a spatial boundary is ignored by the |
| | processing flow |
| Radar spatial | A distinct alarm zone for the radar data wherein a target is filtered based |
| alarm zone | on other criteria, and outside such areas and outside data masks the data |
| | is processed, displayed and saved but not alarmed |
| Image data mask | A filter where all data within a spatial boundary is ignored by the |
| | processing flow |
| Image data spatial | A distinct alarm zone for the radar data wherein a target is filtered based |
| alarm zone | on other criteria, and outside such areas and outside data masks the data |
| | is processed, displayed and saved but not alarmed |

TABLE 2

| Criteria | Description |
|---|---|
| Radar target speed | An alarm threshold that removes or keeps targets that are below, above or |
| threshold | between User defined velocities |
| Radar target | An alarm threshold based on processed radar data that rejects or accepts |
| bearing threshold | data based on the direction of travel of the target based on the change in |
| | angle between a first location of the target and a subsequent location of a |
| | target within a window of processed image data frames |
| Radar Cross | An alarm threshold based on processed radar data that removes or keeps |
| Section threshold | data based on the RCS of the target |
| Radar target | An alarm threshold based on processed radar data that removes or keeps |
| Azimuth and/or | data based on the size of the target or targets based on number of range |
| Range threshold | bins and/or azimuth bins occupied by the target |
| Multiple radar | An alarm threshold based on processed radar data that accepts or rejects |
| target threshold | data based on the number of concurrently detected targets in a defined |
| | area |
| Radar temporal | An alarm threshold based on a window of frames of processed radar data |
| hysteresis | that filters data based on a target remaining detected for fewer than, |
| threshold | greater than or between a User defined number of frames |
| Image data angular | An alarm threshold that removes or keeps targets that are below, above or |
| speed threshold | between User defined velocities based on the detected angular change in |
| | elevation and/or azimuth degrees |
| Image data bearing | An alarm threshold based on processed image data that rejects or accepts |
| threshold | data based on the direction of travel of the target based on the change in |
| | angle of between a first location of the target and a subsequent location of |
| | a target within a window of processed image data frames |
| Image data target | An alarm threshold based on processed image data that accepts or rejects |
| elevation and/or | data based on the size of the target or targets based on number of |
| azimuth size | elevation and/or azimuth pixels occupied by the target |
| threshold | |
| Image target | A filter that accepts or rejects data based on the classification output of |
| classification filter | the target detected in the processed image data which can be used to filter |
| | out false alarms caused by non-geohazards in the scene such as people, |
| | birds, trucks, vehicles, machinery and the like. |

1. A slope failure monitoring system comprising:
a 2D Doppler radar that acquires azimuth and range data of moving radar targets in a scene;
a 2D high definition imaging device operating in an optical frequency band that acquires azimuth and elevation data of moving image targets in the scene;
a processing unit that processes azimuth and range data from the Doppler radar and azimuth and elevation data from the imaging device and:
identifies moving radar targets and moving image targets having matching azimuth data as a moving target;
fuses azimuth and range data from the Doppler radar with azimuth and elevation data from the imaging device and generates azimuth, range and elevation data of the moving target; and
determines a 3D location of the moving target in the scene;
a display that shows at least the scene and the location of the movement in the scene; and
an alarm unit that generates an alarm when movement of the moving target is detected according to criteria.

2. The slope failure monitoring system of claim 1, wherein the 2D Doppler radar and the 2D high definition imaging device are co-located, having a common origin and a common line-of-sight.

3. The slope failure monitoring system of claim 1 wherein the 2D Doppler radar operates in the X radar frequency band.

4. The slope failure monitoring system of claim 1 wherein the 2D high definition imaging device is a video camera that records a sequence of optical images of the scene.

5. The slope failure monitoring system of claim 1 wherein the processing unit is a single device that performs all required processing of data obtained from the Doppler radar and imaging device.

6. The slope failure monitoring system of claim 1 wherein the processing unit comprises multiple devices that process azimuth and range data from the 2D Doppler radar, azimuth and elevation data from the 2D high definition imaging device, identifies moving targets, fuses data to determine the 3D location of the moving target, and applies threshold criteria to generate the alarm.

7. The slope failure monitoring system of claim 1 wherein the criteria are various threshold requirements selected from: movement within a defined area; movement occurring above a set velocity; moving targets above a set size.

8. The slope failure monitoring system of claim 1 further comprising an Input Device for a User to input filters selected from: radar data mask; radar spatial alarm zone; image data mask; image data spatial alarm zone.

9. The slope failure monitoring system of claim 1 further comprising an Input Device for a User to input threshold criteria selected from: Radar target speed; Radar target bearing; Radar Cross Section; Radar target Azimuth and/or Range filter; Multiple radar target; Radar temporal hysteresis; Image data angular speed; Image data target elevation and/or azimuth size; Image target classification.

10. A method of monitoring a slope for failure, including the steps of:
co-locating a 2D Doppler radar and a 2D high definition imaging device at a common origin with a shared or overlapping field of view of a scene; calibrating the Doppler radar and the imaging device to have the same line of sight;
synchronising timing of data collection and processing of data collected from the Doppler radar and the imaging device on one or more processing units using detection and tracking algorithms to detect common moving targets identified by the Doppler radar and the imaging device; and
raising an alarm if a common moving target satisfies one or more criteria.

11. The method of claim 10 further including the step of applying one or more filters to only raise an alarm that pass the filters.

12. The method of claim 10 wherein the step of detecting common moving targets includes identifying moving radar targets and moving image targets having matching azimuth data as a moving target.

13. The method of claim 12 wherein matching azimuth data includes the steps of:
calculating a centroid of each tracked target in azimuth and range for the radar data;
calculating centroid of each tracked target in azimuth and elevation for the imaging device data; and
identifying tracked targets with shared or overlapping azimuth locations as targets with matching azimuth data.

14. The method of claim 13 further including defining a buffer zone to the tracked data for the radar target and defining a buffer zone to the tracked data for the imaging device target and identifying tracked targets with shared or overlapping azimuth locations anywhere within the buffer zone of both the tracked radar target and the tracked imaging device target.

15. The method of claim 14 wherein the buffer zone to the tracked data for the radar target is an angular degree.

16. The method of claim 14 wherein the buffer zone to the tracked data for the imaging device target is a percentage of the size of the target.

17. The method of claim 10 further including the step of determining a 3D location of the moving target in the scene by fusing azimuth and range data from the Doppler radar with azimuth and elevation data from the imaging device to generate azimuth, range and elevation data of the moving target.

18. The method of claim 10 further including the step of displaying on a display device at least the scene and the location of the moving target in the scene.

19. The method of claim 10 further including the step of displaying range indicators on a display device.

20. The method of claim 10 wherein the imaging device is a video camera that records a sequence of optical images of a scene.
